(19) United States
(12) Patent Application Publication
(10) Pub. No.: US 2025/0235988 A1
(43) Pub. Date: Jul. 24, 2025

(54) TORQUE TOOL

(71) Applicant: AKER SOLUTIONS SUBSEA AS, LYSAKER (NO)

(72) Inventors: HARALD NYHUS, OSLO (NO); HENRIK HALDORSEN, HEGGEDAL (NO); OEYSTEIN MOEGEDAL, BORGEN (NO); BARD MELING ERIKSEN, STAVANGER (NO); KENT HAVSTEIN, HUSOEYSUND (NO); GEIR TANDBERG, TRANBY (NO)

(73) Assignee: AKER SOLUTIONS SUBSEA AS, LYSAKER (NO)

(21) Appl. No.: 18/704,462

(22) PCT Filed: Oct. 27, 2022
(86) PCT No.: PCT/NO2022/050247

§ 371 Date: Apr. 25, 2024

(30) Foreign Application Priority Data
Oct. 27, 2021 (GB) 2115449.7

(51) Int. Cl. B25B 21/00; F16K 31/04; F16K 41/04

(52) U.S. Cl. CPC B25B 21/002; F16K 31/041; F16K 41/046

(57) ABSTRACT

A torque tool includes a valve stem interface part, a torque tool housing which contains a fluid, a motor connected to the valve stem interface part, and a first and a second seal which are each arranged between the torque tool housing and an exterior surface of the valve stem interface part. The first seal and the second seal each have a seal body with a first and a second ring. The first and the second ring each have a circular first portion with a free edge, and a second portion. The second portions of each of the first and second ring of each of the first and second seal are connected together. The first and the second seal are axially displaceable and together provide a substantially fluid tight seal between an exterior surface of the valve stem interface part and the torque tool housing.

### CROSS REFERENCE TO PRIOR APPLICATIONS

This application is a U.S. National Phase application under 35 U.S.C. § 371 of International Application No. PCT/NO2022/050247, filed on Oct. 27, 2022 and which claims benefit to Great Britain Patent Application No. 2115449.7, filed on Oct. 27, 2021. The International Application was published in English on May 4, 2023 as WO 2023/075608 A1 under PCT Article 21 (2).

### FIELD

The present invention relates to a torque tool, and in particular, but not exclusively, to a torque tool which is used to actuate a rotary subsea valve.

### BACKGROUND

A typical valve has a valve member which is mounted in a valve body or a housing, the valve member being movable relative to the housing between a closed position in which it impedes a flow of a fluid along a flow passage, and an open position in which it does not significantly impede the flow of the fluid along the flow passage. The valve member is mounted on a stem, which extends through an aperture in the housing, there being a seal assembly provided between the housing and the valve stem which allows for movement of the valve stem in the aperture while substantially preventing a leakage of the fluid from the valve housing via the aperture.

The valve member could be moved between its open and closed positions by rotation of the valve stem about its longitudinal axis, as in a ball valve, or by a translational movement parallel to its longitudinal axis, as in a gate valve.

To operate the valve, there is also provided a drive apparatus, such as an electric motor, which is connected to the stem, potentially via a driveline including a gearing system. The drive system is operable to move the valve stem and to drive a movement of the valve member between its open and closed positions. The drive apparatus may be provided in a retrievable torque tool if the valve member is moved between its open and closed positions by rotation of the valve stem. This may comprise an electric motor which is connected to a valve stem interface part via a gearbox so that operation of the motor drives rotation of the valve stem interface part. The valve stem interface part provides a mechanical coupling to the valve stem so that the rotation of the valve stem interface part is carried through to the rotation of the valve stem.

The motor, gearbox, and valve stem interface are typically mounted in a fluid filled housing, which fluid filled housing has an opening via which the valve stem can be engaged with the valve stem interface. The interior of the housing is connected to a compensator, and seals are provided between the housing and the valve stem interface so as to contain the fluid in the housing while allowing the valve stem interface to rotate relative to the housing. The present invention relates to a new configuration of such seals.

### SUMMARY

An aspect of the present invention is to provide for a new configuration of the above-described seals.

In an embodiment, the present invention provides a torque tool which includes a valve stem interface part having an exterior surface and a longitudinal axis which is parallel to the exterior surface, a torque tool housing having an aperture, an exterior, and an interior which comprises a volume of a fluid, a motor which is connected to the valve stem interface part so that an operation of the motor causes the valve stem interface part to rotate about the longitudinal axis, a first seal, and a second seal. The aperture of the torque tool housing is configured so that the valve stem interface part is accessible from the exterior of the torque tool housing. The first seal is arranged between the torque tool housing and the exterior surface of the valve stem interface part. The first seal comprises a seal body which comprises a first ring and a second ring. The first ring and the second ring each comprise a generally circular first portion having a free edge, and a second portion. The second portion of each of the first ring and the second ring of the first seal are connected together. The second seal is arranged between the torque tool housing and the exterior surface of the valve stem interface part. The second seal comprises a seal body which comprises a first ring and a second ring. The first ring and the second ring each comprise a generally circular first portion having a free edge, and a second portion. The second portion of each of the first ring and the second ring of the second seal are connected together. The first seal and the second seal are each configured to be axially displaceable relative to one another. The first seal and the second seal are configured to together provide a substantially fluid tight seal between the exterior surface of the valve stem interface part and the torque tool housing so as to substantially prevent the fluid in the torque tool housing from leaking out of the torque tool housing via the aperture. The first seal forms a first barrier to a leakage of the fluid along the aperture, and the second seal forms a second barrier to the leakage of the fluid along the aperture.

### BRIEF DESCRIPTION OF THE DRAWINGS

The present invention is described in greater detail below on the basis of embodiments and of the drawings in which:

FIG. 1 is a schematic illustration of a cross-section through a ball valve with a torque tool according to the present invention; and

FIG. 2 is a schematic illustration of the sealing system of the torque tool illustrated in FIG. 1.

### DETAILED DESCRIPTION

A first aspect of the present invention provides a torque tool comprising a housing having an exterior and an interior in which is located a volume of fluid, a motor, and an interface part having an exterior surface and a longitudinal axis which is parallel to the exterior surface, the motor being connected to the interface part so that operation of the motor causes the interface part to rotate about its longitudinal axis, the housing having an aperture via which the interface part may be accessed from the exterior of the housing, the torque tool further comprising first and second seals provided between the housing and the exterior surface of the interface part, the seals being axially displaced relative to one another and together providing a substantially fluid tight seal between the exterior surface of the interface part and the housing to substantially prevent fluid in the housing from leaking out of the housing via the aperture, the first seal forming a first barrier to leakage of fluid along the aperture and the second seal forming a second barrier to leakage of fluid along the aperture, the seals each having a seal body which comprises a first ring and a second ring, the rings each having a generally circular first portion having a free edge and a second portion, the second portions of the rings being connected together, wherein the seals are arranged so that, for each seal, the second portions of both rings are closer to the fluid than the first portions of the rings, and the first portion of the first ring is in contact with the housing and the first portion of the second ring is in contact with the exterior surface of the interface part.

The first portion of the first ring may be in sealing engagement with the housing, and the first portion of the second ring is in sealing engagement with the exterior surface of the interface part.

The seals may have a generally V-shaped or U-shaped cross-section.

Each seal is advantageously provided with a spring which is arranged to urge the first portions of the rings apart, the spring urging the first ring into contact with the housing, and the second ring into contact with the exterior surface of the interface part.

Each spring may be a compression spring which is located in the space between the two rings of the seal body.

The spring of the second seal advantageously urges the first portions of the rings apart with a greater force than the spring of the first seal so that if the fluid is pressurized up to a threshold level, fluid may leak along the aperture past the first seal, but would be prevented from passing the second seal.

The motor may comprise an electric motor.

The motor may be connected to the interface part via a gearing system.

The torque tool may further be provided with a compensator which is connected to the interior of the housing and which acts to equalize the pressure of the fluid in the housing with the pressure of the environmental fluid at the exterior of the housing.

The interface part may comprise a socket.

These and other characteristics will become clear from the following description of illustrative embodiments, which are given as non-restrictive examples, with reference to the attached drawings.

The following description may use terms such as “horizontal”, “vertical”, “lateral”, “back and forth”, “up and down”, “upper”, “lower”, “inner”, “outer”, “forward”, “rear”, etc. These terms generally refer to the views and orientations as shown in the drawings which are associated with a normal use of the present invention. The terms are used for the reader's convenience only and shall not be limiting.

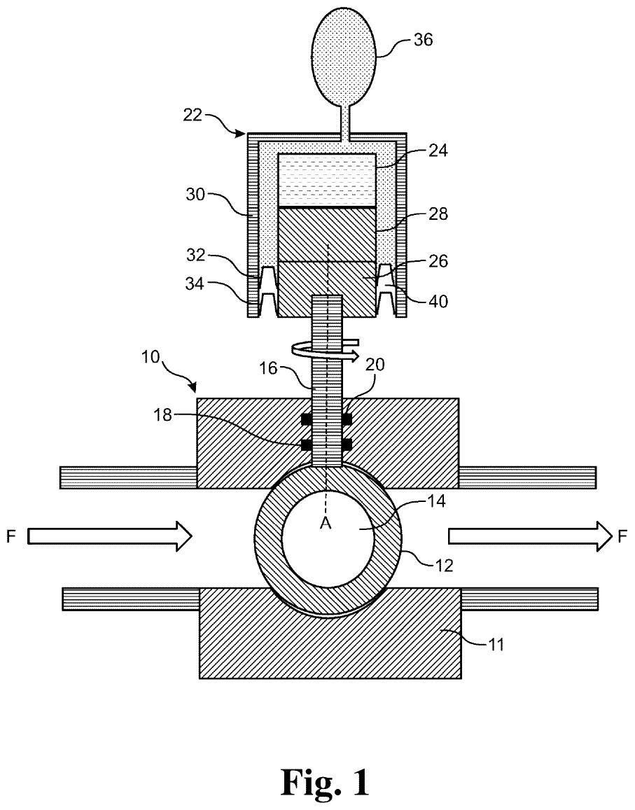

FIG. 1 shows a valve 10 having a housing 11 in which is mounted valve member 12 which is rotatable between a closed position in which the valve member 12 substantially blocks a flow of working fluid along a flow path through the valve 10 (the flow path being illustrated by the arrows labelled F in FIG. 1), and an open position in which the flow of working fluid along the flow path F is permitted. The valve 10 is a ball valve in the shown embodiment and therefore the valve member 12 is generally spherical and is provided with a bore 14 which, when the valve member 12 is in its closed position, is generally perpendicular to the flow path F, the valve member 12 being rotated through 90° to its fully open position in which the bore is aligned with the flow path F.

The valve 10 is also provided with a valve stem 16 having an exterior surface and a longitudinal axis A which is parallel to the exterior surface and which extends through an aperture in the housing 11. A first end of the valve stem 16 is secured to the valve member 12 and is located inside the housing 11, and a second, free, end of the valve stem 16 is located outside of the housing 11. As, in this embodiment, the valve member 12 is rotated between its open position and closed position by rotating the valve stem 16 about its longitudinal axis A, at least a central portion of the valve stem 16 is cylindrical, and the exterior surface of the central portion is curved.

The valve 10 further comprises first and second annular seals 18, 20 which are provided between the housing 11 and the exterior surface of the central portion of the valve stem 16, the first and second annular seals 18, 20 being axially displaced relative to one another and together providing a substantially fluid tight seal between the exterior surface of the valve stem 16 and the housing 11 to substantially prevent a working fluid in the housing 11 from leaking out of the housing 11 via the aperture. The first annular seal 18 forms the first barrier to a leakage of working fluid along the aperture, and the second annular seal 20 forms the second barrier to the leakage of working fluid along the aperture. In other words, the first annular seal 18 is closest to the interior of the housing 11, and the second annular seal 20 is closest to the exterior of the housing 11. The first and second annular seals 18, 20 may be O-rings, lip seals, or any other form of suitable seal as are known to persons skilled in the art.

It should be appreciated, however, that the present invention is not restricted to use with a ball valve. The present invention could be applied to any configuration of valve which comprises a rotatable shaft which is mounted in an aperture in the valve housing.

Also shown in FIG. 1 is a torque tool 22 which can be used to rotate the valve member 12 between its open and closed positions. The torque tool 22 could be permanently or semi-permanently mounted on the valve 10, and operated exclusively to open or close that particular valve 10, being removed or replaced only when faulty or when operation of the valve 10 is no longer required. The torque tool 22 could alternatively be a tool which is moved from valve to valve, by a human operator or by an ROV, to open or close different valves in succession.

The torque tool 22 comprises a motor 24 which is connected to a valve stem interface part 26 via a gearbox 28 so that operation of the motor 24 causes a rotation of the valve stem interface part 26. In one embodiment, the motor 24 is an electric motor, but it will be appreciated that any other device which, when powered, can produce a rotational movement could instead be used (for example, a hydraulic motor).

The valve stem interface part 26 provides a releasably mechanical coupling to the valve stem 16 so that the rotation of the valve stem interface part 26 is carried through to rotation of the valve stem 16.

The valve stem interface part 26 may, for example, comprise a socket into which the free end of the valve stem 16 can be inserted. The free end of the valve stem 16 has in this case a non-circular transverse cross-section (for example, hexagonal), with the socket of the valve stem interface part 26 having a corresponding shape.

The motor 24, gearbox 28, and valve stem interface part 26 are mounted in a torque tool housing 30, which has an opening via which the valve stem 16 can be engaged with the valve stem interface part 26. The interior of the torque tool housing 30 is filled with a fluid (e.g., oil) and is connected to a compensator 36, with seals 32, 34 being provided between the torque tool housing 30 and the valve stem interface part 26 so as to contain the fluid in the torque tool housing 30 while allowing the valve stem interface part 26 to rotate relative to the housing.

A first seal 32 forms the first barrier to leakage of housing fluid and a second seal 34 forms the second barrier to leakage of housing fluid. In other words, the first seal 32 is closest to the interior of the torque tool housing 30, and the second seal 34 is closest to the exterior of the torque tool housing 30. The seals 32, 34 also prevent an ingress of fluid from the environment (environmental fluid) surrounding the torque tool housing 30 (sea water if the valve is actuated subsea) into the torque tool housing 30, the second seal 34 forming a first barrier to the ingress of environmental fluid into the torque tool housing 30, and the first seal 32 providing a second barrier to the ingress of environmental fluid into the torque tool housing 30.

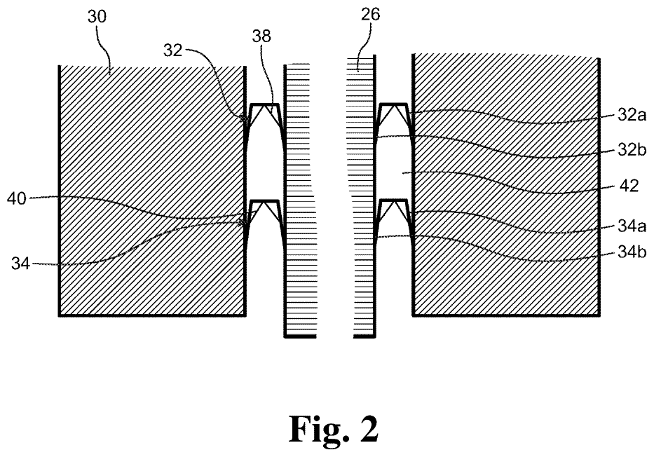

The seals 32, 34 are lip seals and are illustrated in detail in FIG. 2, where it can be seen that each of the seals 32, 34 has a seal body which comprises a first ring 32a, 34a and a second ring 32b, 34b. The rings 32a, 32b, 34a, 34b each have a generally circular first portion with a free edge and a second portion, the second portions of the rings 32a, 32b, 34a, 34b in each seal 32, 34 being connected together. As such, in this embodiment, the seals 32, 34 have a seal body with a generally U-shaped cross-section. It should be appreciated, however, that this need not be the case, and that the seals 32, 34 could equally have a seal body with a generally V-shaped cross-section.

The seal body is advantageously made from a flexible and resilient polymer such as rubber or PTFE.

The seals 32, 34 are arranged so that the second portions of the rings 32a, 32b, 34a, 34b of both seals 32, 34 (i.e., the base of the V/U) are closer to the fluid in the torque tool housing 30 than the first portions of the rings 32a, 32b, 34a, 34b of both seals 32, 34.

The seals 32, 34 are each provided with a spring 38, 40 which is arranged between the two rings 32a, 32b, 34a, 34b of each seal 32, 34 to urge the first portions of the rings 32a, 32b, 34a, 34b apart. In this embodiment, the spring 38, 40 urges the first ring 32a, 34a into contact with the torque tool housing 30 and the second ring 32b, 34b into contact with the valve stem interface part 26.

In this embodiment, the springs 38, 40 are compression springs, which in this embodiment are annular and have a generally V-shaped cross-section, and are made from a metal such as a spring steel. The springs 38, 40 are compressed to bring their free edges together for insertion into the space between the two rings 32a, 32b, 34a, 34b of each seal body, and then released so that each of the free edges engages with one of the rings 32a, 32b, 34a, 34b of the seal body. It will be appreciated by a skilled person that other configurations of spring could equally be used. The spring could, for example, have a U-shaped cross-section, or be toroidal in shape. The spring could be metallic (i.e., made from a spring steel) or be made from an elastomeric material. Each spring 38, 40 could moreover, in fact, comprise a plurality of springs.

The compensator 36 provides that the fluid in the torque tool housing 30 is pressure balanced with the fluid pressure at the exterior of the housing 11 (the environmental fluid pressure). When the torque tool 22 is assembled, the fluid pressure in the torque tool housing 30 will therefore be at atmospheric pressure, or perhaps at a pressure which is slightly higher than atmospheric pressure, but if the torque tool 22 is used subsea, the compensator 36 will provide that the pressure of the fluid inside the torque tool housing 30 increases to match the water pressure at the depth to which the torque tool 22 is lowered.

There is, however, a small volume of trapped fluid 42 in the space between the seals 32, 34, and this trapped fluid 42 will be at atmospheric pressure and is not pressure balanced with the environmental fluid pressure. As such, if the two seals 32, 34 provide a perfect seal between the torque tool housing 30 and the valve interface part 26, the pressure of this trapped fluid 42 will stay at atmospheric pressure even when the torque tool 22 is used subsea and is exposed to an environmental fluid pressure which is substantially greater than atmospheric pressure. This would create a pressure differential across the seals 32, 34, each seal 32, 34 being exposed to fluid at the subsea fluid pressure on one side, and atmospheric pressure on the other side. When the torque tool 22 is used at significant depths, this pressure differential can be high, for example, around 400 Bar (40,000 kPa) when the valve 19 is used at a depth of 4,000 m.

In some embodiments, the fluid in the torque tool housing 30 may be pressurized to a pressure which is slightly above atmospheric pressure when the torque tool 22 is assembled. The trapped fluid 42 will in this case be at a pressure which is slightly above atmospheric pressure. Nevertheless, if only a slight over-pressure is applied, there may still be a significant pressure differential across the seals 32, 34 when the torque tool 22 is used at depth.

This pressure differential can cause frictional drag between the seals 32, 34 and the valve interface part 26 which impedes the rotational movement of the valve stem interface part 26 which is required to rotate the valve stem 16 and actuate the valve 10. There can consequently be a significant variation in the torque required to rotate the valve stem 16 depending on the depth at which the valve 10 is located. This can make accurate control of the valve movement tricky, as the torque applied by the motor 24 to the valve stem interface part 26 is known, but what this translates to in terms of the torque applied to the valve member 12 is not known. Moreover, to provide a motor 24 which is capable of overcoming the frictional drag on the valve stem interface part 26 when the valve 10 is used at great depths, it will be necessary to provide a significantly more powerful (and therefore larger) motor 24 than would be required to operate the valve 10 at lower depths.

This problem may be alleviated by using the arrangement of the seals 32, 34 described above.

Considering the second seal 34, it will be appreciated that the pressurized environmental fluid would act with the spring 40 to force the first portions of the rings 34a, 34b apart against the torque tool housing 30 or the valve stem interface part 26 respectively, thus increasing the effectiveness of the seal and reducing the chances of environmental fluid passing the seal 34.

In contrast, considering the first seal 32, the pressurized fluid inside the torque tool housing 30 will act against the spring 38 to urge the first portions of the rings 32a, 32b together and out of sealing engagement with the torque tool housing 30 and the valve stem interface part 26, thus reducing the effectiveness of the seal. There may thus be some leakage of fluid in the torque tool housing 30 past the first seal 32 into the space between the seals 32, 34, thus increasing the pressure of the trapped fluid 42. This would reduce the pressure differential across the seals 32, 34 and reduce the frictional drag on the valve stem interface part 26.

The spring 40 of the second seal 34 is advantageously more powerful than the spring 38 of the first seal 34, and therefore urges the first portions of the rings 34a, 34b apart with a greater force than the spring 38 of the first seal 32. This means that if the fluid in the torque tool housing 30 is pressurized up to a threshold level, fluid may leak past the first seal 32 into the volume of trapped fluid 42, but be prevented from passing the second seal 32.

It will be appreciated that, by virtue of this arrangement, the pressure of the fluid between the seals 32, 34 is elevated to match or be close to the environmental pressure at depth. When the torque tool 22 is brought back to the surface from use at depth, the fluid between the seals 32, 34 could be higher than atmospheric pressure. However, when the pressure differential across the second seal 34 is high enough, the pressurized fluid trapped between the seals 32, 34 will act against the spring 40 to urge the first portions of the rings 34a, 34b together and out of sealing engagement with the housing 30 and valve stem interface part 26, thereby reducing the effectiveness of the second seal 34. There may thus be some leakage of fluid from the volume between the seals 32, 34 past the second seal 34 to the exterior of the torque tool housing 30, thus reducing the pressure of the trapped fluid 42.

It should be appreciated that while the present invention is described above in relation to a torque tool for use in actuating a subsea valve, this need not be the case, and may be applied to a torque tool used in other applications which requires the rotation of a part. It could, for example, be applied to a torque tool used for securing a bolt in a flanged coupling of a subsea pipeline. As before, the torque tool could be permanently or semi-permanently mounted on the part in question, and operated exclusively to rotate that particular part, being removed or replaced only when faulty or when rotation is no longer required. It could alternatively be a tool which is moved from part to part, by a human operator or by an ROV, to rotate different parts in succession.

The present invention is not limited by the embodiments described above; reference should also be had to the appended claims.

### LIST OF REFERENCE CHARACTERS

10 Valve
11 Housing
12 Valve member
14 Bore
16 Valve stem
18 First annular seal
20 Second annular seal
22 Torque tool
24 Motor
26 Valve stem interface part
28 Gearbox
30 Torque tool housing
32 First seal
32a First ring
32b Second ring
34 Second seal
34a First ring
34b Second ring
36 Compensator
38 Spring
40 Spring
42 Trapped fluid
A Longitudinal axis
F Flow path

What is claimed is:

1-10. (canceled)

11. A torque tool comprising:
a valve stem interface part having an exterior surface and a longitudinal axis which is parallel to the exterior surface;
a torque tool housing having an aperture, an exterior, and an interior which comprises a volume of a fluid, the aperture of the torque tool housing being configured so that the valve stem interface part is accessible from the exterior of the torque tool housing;
a motor which is connected to the valve stem interface part so that an operation of the motor causes the valve stem interface part to rotate about the longitudinal axis;
a first seal which is arranged between the torque tool housing and the exterior surface of the valve stem interface part, the first seal comprising a seal body which comprises a first ring and a second ring, the first ring and the second ring each comprising a generally circular first portion having a free edge, and a second portion, the second portion of each of the first ring and the second ring of the first seal being connected together; and
a second seal which is arranged between the torque tool housing and the exterior surface of the valve stem interface part, the second seal comprising a seal body which comprises a first ring and a second ring, the first ring and the second ring each comprising a generally circular first portion having a free edge, and a second portion, the second portion of each of the first ring and the second ring of the second seal being connected together,
wherein,
the first seal and the second seal are each configured to be axially displaceable relative to one another,
the first seal and the second seal are configured to together provide a substantially fluid tight seal between the exterior surface of the valve stem interface part and the torque tool housing so as to substantially prevent the fluid in the torque tool housing from leaking out of the torque tool housing via the aperture,
the first seal forms a first barrier to a leakage of the fluid along the aperture, and
the second seal forms a second barrier to the leakage of the fluid along the aperture.

12. The torque tool as recited in claim 11, wherein,
the first portion of each first ring is in a sealing engagement with the torque tool housing, and
the first portion of each second ring is in a sealing engagement with the exterior surface of the valve stem interface part.

13. The torque tool as recited in claim 11, wherein each of the first seal and the second seal have a generally V-shaped cross section or a generally U-shaped cross-section.

14. The torque tool as recited in claim 11, wherein,
the first seal further comprises a spring which is arranged to urge the first portion of the first ring and the first portion of the second ring apart, and to urge the first ring into a contact with the torque tool housing and the second ring into a contact with the exterior surface of the valve stem interface part, and
the second seal further comprises a spring which is arranged to urge the first portion of the first ring and the first portion of the second ring apart, and to urge the first ring into a contact with the torque tool housing and the second ring into a contact with the exterior surface of the valve stem interface part.

15. The torque tool as recited in claim 14, wherein,
the spring of the first seal is a compression spring which is arranged in a space between the first ring and the second ring of the seal body, and
the spring of the second seal is a compression spring which is arranged in a space between the first ring and the second ring of the seal body.

16. The torque tool as recited in claim 14, wherein,
the spring of the first seal urges the first portion of the first ring and the first portion of the second ring apart with a first force,
the spring of the second seal urges the first portion of the first ring and the first portion of the second ring apart with a second force, and
the second force is greater than the first force.

17. The torque tool as recited in claim 11, wherein the motor is an electric motor.

18. The torque tool as recited in claim 11, further comprising:
a gearing system,
wherein,
the motor is connected to the valve stem interface part via the gearing system.

19. The torque tool as recited in claim 11, further comprising:
a compensator which is connected to the interior of the torque tool housing, the compensator being configured to equalize a pressure of the fluid in the torque tool housing with a pressure of an environmental fluid at the exterior of the torque tool housing.

20. The torque tool as recited in claim 11, wherein the valve stem interface part comprises a socket.
